(19) United States
(12) Patent Application Publication
(10) Pub. No.: US 2013/0184010 A1
(43) Pub. Date: Jul. 18, 2013

(54) TRANSMITTING LOCATION INFORMATION FROM A COMPUTING DEVICE

(71) Applicants: Isaac Lagnado, Houston, TX (US); Henry F. Lada, JR., Cypress, TX (US); Scott W. Briggs, Cypress, TX (US)

(72) Inventors: Isaac Lagnado, Houston, TX (US); Henry F. Lada, JR., Cypress, TX (US); Scott W. Briggs, Cypress, TX (US)

(21) Appl. No.: 13/816,651

(22) PCT Filed: Aug. 13, 2010
(86) PCT No.: PCT/US10/45501

§ 371 Date: Feb. 12, 2013

(51) Int. Cl. H04W 4/02

(52) U.S. Cl. CPC H04W 4/025
USPC 455/456.2

(57) ABSTRACT

A wireless communication module on a portable communication device transmits location information about the device via text messaging in response to receiving a text message request for location information. In various embodiments, the wireless communication module transmits location information when a computing platform on the portable communication device is in a non-operative state.

### BACKGROUND

Portable computing devices are valuable to their owners both in terms of the cost of the device and the information stored on the device. For a portable computing device that is lost or stolen, it may be possible to track the device; however, various tracking tools rely on installation of software programs which may need to be running the background to be effective.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram illustrating a system according to various embodiments.

FIG. 2 is a block diagram illustrating a system according to various embodiments.

FIG. 3 is a flow diagram of operation in a system according to various embodiments.

FIG. 4 is a flow diagram of operation in a system according to various embodiments.

### DETAILED DESCRIPTION

Various embodiments described herein allow portable computing devices (e.g., notebook computers, tablet computers, mobile devices, smartphones, etc.) to be tracked in various power states including OFF, ON, hibernate, standby, sleep, etc.

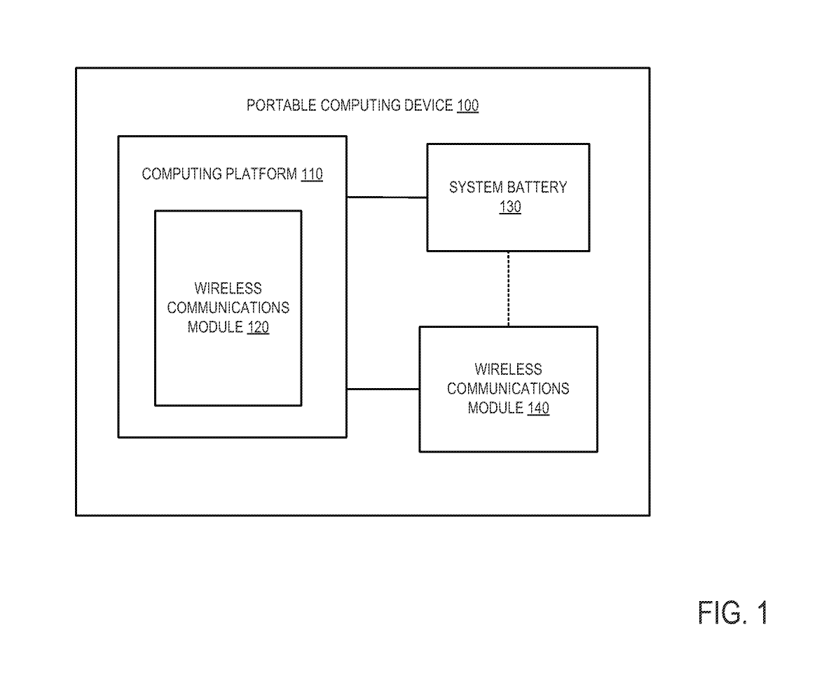

FIG. 1 is a block diagram illustrating a computing device according to various embodiments. FIG. 1 includes particular components, modules, etc. according to various embodiments. However, in different embodiments, other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

Portable computing device 100 includes a computing platform 110 having a first wireless communications module 120, a system battery 130 and a second wireless communications module 140. As used herein, a computing platform refers to a computing device's hardware architecture and associated software framework. For example, in a typical notebook computer, the computing platform might include a central processing unit (CPU), a memory controller hub (e.g., Northbridge), an I/O controller hub (e.g., Southbridge), a firmware interface (e.g., BIOS, EFI, etc.), and an operating system. More, fewer, or different components could constitute a computing platform. As shown, computing platform 110 includes wireless communications module 120, which can be a wireless local area network (WLAN) module or other wireless module.

System battery 130 can be any type battery used to power a portable computing device. Examples of batteries include, but are not limited to, rechargeable lithium-ion batteries, nickel-metal hydride batteries and the like. Computing platform 110 and wireless communications module 120 are dependent, at least intermittently, on system battery 130 for power. In other words, assuming computing device 100 is not plugged into a power source (e.g., an AC outlet), computing platform 110 (including wireless communications module 120) is non-operative when power from system battery 130 is exhausted, and/or battery 130 is removed from computing device 100. Additionally, computing platform 110 could be placed in a non-operative state (e.g., hibernate, sleep, suspend, OFF) by a user despite having available power from battery 130. In this non-operative state, power is removed from all unused devices (e.g., module 120).

Wireless communications module 140 is capable of communicating with computing platform 110 when computing platform 110 is in an operative state. For example, wireless communications module 140 might receive data in a wireless transmission and pass the data to computing platform 110 for processing.

Wireless communications module 140 is capable of maintaining an operative state with a network even as the computing platform 110 is in a non-operative state, as long as power is maintained to module 140. Thus, communications module 140 can transmit and receive information (e.g., location information about computing device 100) even when computing platform 110 is in a non-operative state. For example, wireless communications module 140 could be a cellular network module (e.g., wireless wide area network or WWAN module) though embodiments are not limited as such. Wireless communications module 140 could be powered by battery 130 or it could be powered by a separate battery, perhaps one that is isolated from computing platform 110. In either case, wireless communications module 140 transmits location information about computing device 100 even when computing platform 110 is in a non-operative state. In particular, location information is transferred via one or more text message exchanges (e.g., short message service or SMS).

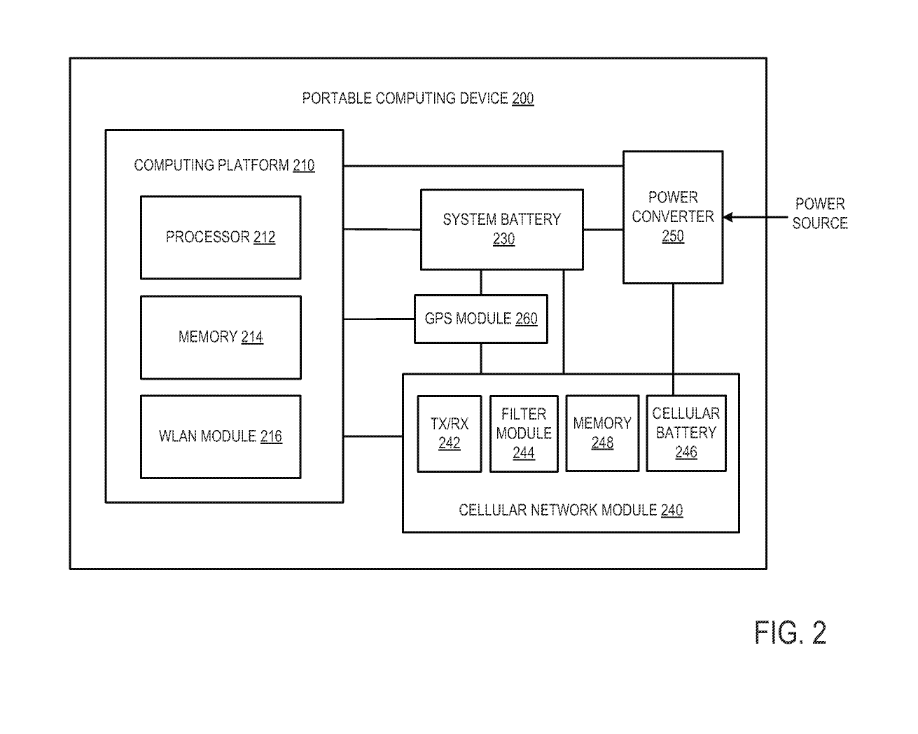

FIG. 2 is a block diagram of a system according to various embodiments. FIG. 2 includes particular components, modules, etc. according to various embodiments. However, in different embodiments, other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

Portable computing device 200 could be one of various types of devices, including notebook computers, tablet computers, smartphones, e-readers, and the like. Computing platform 210 includes processor 212, memory 214 and WLAN module 216. System battery 230 powers computing platform 210 when a connection to a power source is not available or otherwise not used. Power converter 250 converts AC power from a power source to DC power, which is used to power computing platform 210 and/or charge system battery 230 when computing device 200 is connected to the power source.

Computing platform 210 can be placed in one of multiple power states depending on available power, usage, and/or user input. Examples of power states include ON, hibernate, suspend, sleep, OFF, etc. Certain power states (e.g., hibernate, suspend, sleep, OFF, etc.) cause computing platform 210 to be in a non-operative state. In other words, in the non-operative power states, functionality of computing platform 210 may be limited and/or unavailable. For example, the operating system may be unavailable when computing platform 210 is in a non-operative state. In various embodiments, the wireless communications functionality of WLAN module 216 is unavailable when computing platform 216 is in a non-operative state.

Cellular network module 240 is capable of communicating with computing platform 210 when computing platform 210 is in an operative state. For example, cellular network module 240 may be connected to computing platform 210 via one or more interfaces (e.g., USB (universal serial bus), SIM (subscriber identification module) card, LED (light emitting diode), etc.). However, when computing platform 210 is in a non-operative state, cellular network module 240 may remain in an operative state. In other words, cellular network module 240 becomes virtually isolated from computing platform 210 when computing platform 210 is in a non-operative state. For example, cellular network module 240 can send and receive transmissions (e.g., text messages) via transmitter/receiver 242 even when computing platform 210 is in a non-operative state. Cellular network module 240 is powered by cellular battery 246, at least when portable computing device 200 does not provide power to cellular network module 240, which can occur during any of the non-operative states. As shown, cellular battery 246 is isolated from computing platform 210 and is charged via power converter 250 whether device 200 is on external power or whether it is on system battery 230 power. Though the operational state of cellular network module 240 is not necessarily tied to the operational state of computing platform 210, cellular network module 240 may be powered, in certain embodiments, by system battery 230. Also, in some embodiments, cellular battery 246 might be alternatively charged via system battery 230. Cellular battery 246 could also serve as a backup battery for times when system battery 230 and/or the external power source fails to provide a threshold level power to cellular network module 240.

Given the independent operational state of cellular network module 240, transmitter/receiver 242 is capable of sending and receiving wireless transmissions, including text messages (e.g., SMS messages). In various embodiments, receiver 242 receives a text message. Filter module 244 detects a request for location information in the text message. For example, filter module 244 may look for a specific pattern of characters and/or bits, which if detected, signify a request for location information about computing device 200.

One type of request for location information might be a request for the last known location of computing device 200. Another type of request might be a request for the current location of computing device 200. Another type of request might be a request to periodically receive current location information for a fixed or indefinite period of time. Yet another type of request might be a request to periodically receive current location information anytime a certain change in location has been detected, for example a change in location by 1000 m could trigger a new location update to be transmitted. Other types of requests could also be detected by filter module 244.

There may be one type of location information request or multiples types that can be sent in a text message. A text message request may also include one or more parameters about the request (timing, frequency, etc.). In particular, a text message request may include a location change threshold parameter which indicates a threshold change in distance that triggers a current location update. For example, a location change threshold parameter could be set at a distance of one thousand meters. Thus, whenever device 200 moves one thousand meters from the location where the last location update was transmitted, a new location update is automatically transmitted.

Cellular network module 240 is connected to global positioning satellite (GPS) module 260. GPS module 260 provides location and time information from locations around the world based on communication with GPS satellites (usually at least four). While GPS module 260 is shown embedded within cellular network module 240, it is possible that other embodiments have a separate GPS module that is not embedded within cellular network module 240. As shown, GPS module 260 is powered by cellular battery 246; however, it could also be powered independently by system battery 230 in certain embodiments. GPS module 260 can be maintained in an operative state corresponding to the operative state of cellular network module 240 or it can be switched to an operative state on an as-needed basis.

GPS module 260 periodically provides location information and may include a corresponding timestamp to cellular network module 240 for storage in memory 248. Thus, when a request for a last known location of computing device 200 is detected, the most recent location information from GPS module 260 is retrieved from memory 248. In particular, if GPS module 260 is in a non-operative state when a request for location information is received, then the last known location information is retrieved from memory 248. In some embodiments, there may be storage for information regarding multiple last known locations within the memory 248, such that if requested the cellular network module 240 may provide a list of last known locations and time stamps. In some embodiments, the operational state of GPS module 260 could be tied to the operational state of computing platform 210, meaning that GPS module 260 may not always be available to provide current location information. When GPS module 260 is in an operative state and a request for current location information is detected, GPS module 260 acquires and provides the current location of computing device 200 to cellular network module 240. GPS module 260 can be powered by computing platform 210, cellular network module 240, and/or system battery 230 in various embodiments.

While various embodiments illustrate the use of GPS module 260, other forms of location detection could be used in alternate embodiments. For example, cellular module 240 can triangulate its position from information about its data connection and registration with various cellular base stations. When in an operative state, WLAN module 120 could provide internet access information such as IF Address/Gateway Address that could be stored in memory 248 and also be used to determine location and/or provide location information when computing platform 210 is in a non-operative state.

Various modules and/or components illustrated in FIG. 2 may be implemented as a computer-readable storage medium containing instructions executed by a processor (e.g., processor 212 or 262) and stored in a memory (e.g., memory 214 or 248).

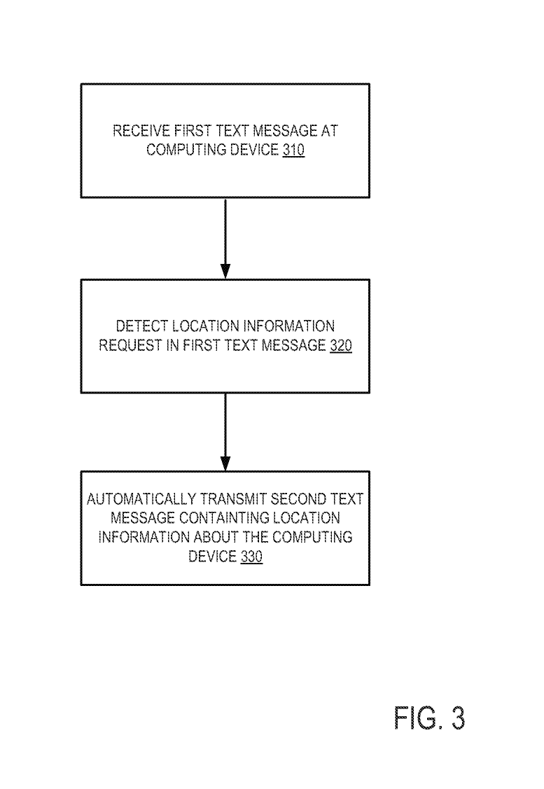

FIG. 3 is a flow diagram of operation in a system according to various embodiments. FIG. 3 includes particular operations and execution order according to certain embodiments. However, in different embodiments, other operations, omitting one or more of the depicted operations, and/or proceeding in other orders of execution may also be used according to teachings described herein.

A computing device (e.g., such as a notebook computer, tablet computer, mobile phone, smartphone, etc.) receives 310 a text message (e.g., sent using Short Message Service, or SMS) via a wireless communications module. In various embodiments, the wireless communications module is housed within the computing device. The computing device detects 320 a request for location information in the text message. For example, the computing device might include a filter or detection mechanism that analyzes the text message for a predefined pattern of characters and/or bits. A text message having the predefined pattern of characters and/or bits is detected as a request for location information. There may exist multiple types of location information requests, each having a different predefined pattern of characters and/or bits associated with the text message.

When a request for location information is detected, the location information is automatically obtained, either from memory or directly from a location module, such as a GPS module. The computing device then (automatically) transmits 330 a response text message containing the obtained location information about the computing device. The response text message may be transmitted back to the original requester of the location information or it may be transmitted to a different entity. In some embodiments, the location information is transmitted to multiple entities.

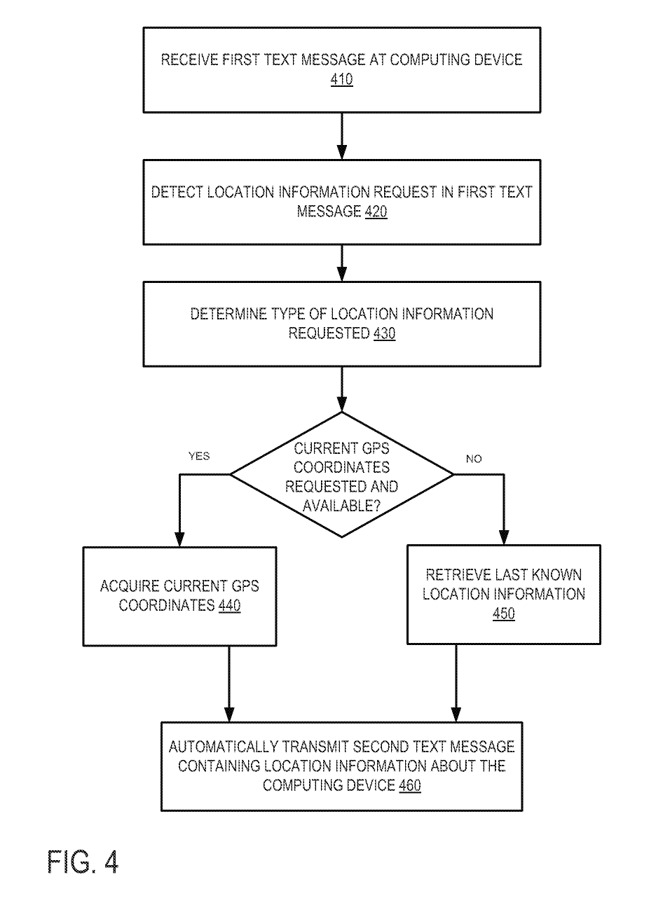

FIG. 4 is a flow diagram of operation in a system according to various embodiments. FIG. 4 includes particular operations and execution order according to certain embodiments. However, in different embodiments, other operations, omitting one or more of the depicted operations, and/or proceeding in other orders of execution may also be used according to teachings described herein.

A computing device receives 410 a first text message from a source. This text may be received by a wireless communication module (e.g., cellular network module) on the computing device that remains operational even when the computing platform on the computing device is in a non-operative state. The computing device detects 420 a request for location information in the first text message. As discussed previously, the request for location information may be detected based on a predefined pattern of characters and/or bits associated with the text message. In various embodiments, the request for location information is specific to the computing device which receives the first text message. In other words, the first text message is a request for information about the location of the computing device.

The computing device determines 430 the type of location information requested in the first text message. In various embodiments, the computing device includes a GPS module for acquiring location information. If current location information is requested and available, then the computing device (e.g., via the GPS module) acquires 440 the current GPS coordinates of the device. If, however, the request does not call for current location information or if the current location is unavailable (e.g., GPS module is in a non-operative state, GPS satellites are unavailable due to weather or other obstruction, etc.), then the computing device retrieves 450 (e.g., from memory) the last known location information about the computing device.

Once the location information has been acquired and/or retrieved, the computing device—in particular, the wireless communications module on the computing device—automatically transmits 460 a second text message containing the location information. The second text message may be transmitted to the source of the first text message and/or to a different recipient. Accordingly, the location of the computing device can be determined remotely by sending a text message to the device and receiving a response text message containing the location information. More particularly, location of the computing device can be determined using a cellular network module that operates and/or is powered independently from the computing platform on the computing device. Thus, location tracking can be enabled and reported remotely even if the computing platform on the computing device is in a non-operative state.

Various modifications may be made to the disclosed embodiments and implementations of the invention without departing from their scope. Therefore, the illustrations and examples herein should be construed in an illustrative, and not a restrictive sense.

1. A computing device, comprising:
a computing platform including a first wireless communications module;
a first battery to power, at least intermittently, the computing platform; and
a second wireless communications module separate from the computing platform that is capable of communicating with the computing platform when the computing platform is in an operative state and that is capable of automatically transmitting location information about the computing device when the computing platform is in a non-operative state, the location information transmitted via one or more text messages in response to receiving a location information request.

2. The computing device of claim 1, wherein the first wireless communications module is a wireless local area network (WLAN) module and the second wireless communications module is a cellular network module.

3. The computing device of claim 1, the first battery further to provide power, at least intermittently, to the second wireless communications module.

4. The computing device of claim 3, wherein the second communications module further comprises:
a second battery to power the second wireless communications module if the first battery fans to provide a threshold level of power to the second wireless communications module, wherein the second battery is isolated from the computing platform.

5. The computing device of claim 1, wherein the location information request is received via one or more text messages.

6. The computing device of claim 2, wherein the second communications module further comprises:
a receiver to receive one or more text messages;
a filter module to detect a location trigger mask in a received text message; and
a GPS module to retrieve GPS location information about the computing device; and
a transmitter to transmit the location information via one or more text messages.

7. The computing device of claim 6, wherein the received text message is from an entity registered with the second communications module and wherein the GPS location information is transmitted to the entity.

8. A method, comprising:
receiving a first text message at a wireless communications module on a portable computing device;
detecting in the first text message a request for location information; and
automatically transmitting a second text message containing location information about the portable computing device in response to detecting the request.

9. The method of claim 8, wherein receiving the first text message and automatically transmitting the second text message occur while a computing platform on the portable computing device is in a non-operative state.

10. The method of claim 9, further comprising:
determining that the request for location information includes a request for a last known location of the portable computing device corresponding to a time period when the computing platform was last in an operative state; and
providing the last known location of the portable computing device in the second text message.

11. The method of claim 8, further comprising:
determining that the request for location information includes a request for current location coordinates of the portable computing device;
acquiring the current location coordinates;
providing the current location coordinates in the second text message.

12. The method of claim 8, further comprising:
determining that the request for location information includes a request for periodic updates of current location coordinates of the portable computing device;
periodically acquiring current location coordinates of the portable computing device; and
providing the current location coordinates for text message transmission.

13. A computing device, comprising:
means for receiving a first text message at a wireless communications module housed within a portable computing device while a computing platform on the portable computing device is in a non-operative state;
means for detecting in the first text message a request for location information while the computing platform is in the non-operative state; and
means for automatically transmitting a second text message while the computing platform is in a non-operative state, the second text message containing location information about the portable computing device in response to detecting the request.

14. The computing device of claim 13, further comprising:
means for providing a last known location of the portable computing device in the second text message, the last known location corresponding to a time period when the computing platform was last in an operative state.

15. The computing device of claim 13, wherein the request for location information in the first text message includes a location change threshold parameter, the computing device further comprising:
means for providing the current location coordinates in the second text message in response to a change in location that satisfies the location change threshold parameter.
